(19) United States
(12) Patent Application Publication
(10) Pub. No.: US 2015/0257018 A1
(43) Pub. Date: Sep. 10, 2015

(54) COMMUNICATION APPARATUS, COMMUNICATION SYSTEM AND ENERGY MANAGEMENT APPARATUS

(71) Applicant: KABUSHIKI KAISHA TOSHIBA, Minato-ku (JP)

(72) Inventors: Yuji TOHZAKA, Kawasaki (JP); Hiroki KUDO, Kawasaki (JP); Takafumi SAKAMOTO, Machida (JP)

(73) Assignee: KABUSHIKI KAISHA TOSHIBA, Minato-ku (JP)

(21) Appl. No.: 14/591,513

(22) Filed: Jan. 7, 2015

(30) Foreign Application Priority Data
Mar. 10, 2014 (JP) 2014-046831

(51) Int. Cl. H04W 24/04; H04L 12/24; H04L 29/08; H04W 40/24

(52) U.S. Cl. CPC H04W 24/04; H04W 40/246; H04L 41/0816; H04L 67/12; H04W 84/20

(57) ABSTRACT

According to an embodiment, a communication apparatus includes a communicator, an acquisition unit and a controller. When an operation mode is a first mode, the communicator functions as a hub of a network to communicate with another communication apparatus in the network. When the operation mode is a second mode, the communicator communicates with another communication apparatus in the network without functioning as the hub. The acquisition unit acquires communication quality information indicating a communication quality of each link in the network. When the operation mode of the communicator is the first mode, the controller decides based on the communication quality information whether to set the operation mode of the communicator to the second mode.

### CROSS-REFERENCE TO RELATED APPLICATIONS

This application is based upon and claims the benefit of priority from Japanese Patent Application No. 2014-046831, filed Mar. 10, 2014, the entire contents of which are incorporated herein by reference.

### FIELD

Embodiments described herein relate generally to communication.

### BACKGROUND

In a star network (for example, a wireless LAN (Local Area Network)), if a communication failure occurs in a master device (for example, an AP (Access Point)) corresponding to a hub, all communication processes in the network become impossible. When such communication failure occurs, one slave device (for example, an STA (STAtion)) selected in advance can serve as a new master device to reconstruct a new star network with the remaining slave devices. This technique may improve the reliability of a star network. However, when the technique is used, it is not always clearly defined how the previous master device should get involved in the new network.

### BRIEF DESCRIPTION OF THE DRAWINGS

FIG. 1 is a block diagram exemplifying a communication apparatus according to the first embodiment;

FIG. 2 is a flowchart exemplifying the operation of the communication apparatus shown in FIG. 1;

FIG. 3 is a flowchart exemplifying the operation of the communication apparatus shown in FIG. 1;

FIG. 4 is a view for explaining an example of the operation of a communication system including the communication apparatus shown in FIG. 1;

FIG. 5 is a sequence chart exemplifying the operation of the communication system including the communication apparatus shown in FIG. 1;

FIG. 6 is a view for explaining an example of the operation of the communication system including the communication apparatus shown in FIG. 1;

FIG. 7 is a flowchart exemplifying the operation of the communication apparatus shown in FIG. 1;

FIG. 8 is a flowchart exemplifying the operation of the communication apparatus shown in FIG. 1;

FIG. 9 is a view for explaining an example of the operation of the communication system including the communication apparatus shown in FIG. 1;

FIG. 10 is a flowchart exemplifying the operation of the communication apparatus shown in FIG. 1;

FIG. 11 is a flowchart exemplifying the operation of the communication apparatus shown in FIG. 1;

FIG. 12 is a view for explaining an example of the operation of the communication system including the communication apparatus shown in FIG. 1;

FIG. 13 is a flowchart exemplifying the operation of the communication apparatus shown in FIG. 1;

FIG. 14 is a flowchart exemplifying the operation of the communication apparatus shown in FIG. 1;

FIG. 15 is a view for explaining an example of the operation of the communication system including the communication apparatus shown in FIG. 1;

FIG. 16 is a flowchart exemplifying the operation of the communication apparatus shown in FIG. 1;

FIG. 17 is a flowchart exemplifying the operation of the communication apparatus shown in FIG. 1;

FIG. 18 is a view for explaining an example of the operation of the communication system including the communication apparatus shown in FIG. 1;

FIG. 19 is a block diagram exemplifying a communication system according to the second embodiment; and

FIG. 20 is a block diagram exemplifying an energy management apparatus according to the third embodiment.

### DETAILED DESCRIPTION

Embodiments will be described below with reference to the accompanying drawings.

According to an embodiment, a communication apparatus includes a communicator, an acquisition unit and a controller. When an operation mode is a first mode, the communicator functions as a hub of a network to communicate with another communication apparatus in the network. When the operation mode is a second mode, the communicator communicates with another communication apparatus in the network without functioning as the hub of the network. The acquisition unit acquires communication quality information indicating a communication quality of each link in the network. When the operation mode of the communicator is the first mode, the controller decides based on the communication quality information whether to set the operation mode of the communicator to the second mode.

Note that the same or similar reference numerals denote the same or similar elements hereinafter and a repetitive description thereof will be basically omitted.

Although the following description assumes a star network topology, each embodiment is applicable to other types of network topologies. Furthermore, the following description assumes that a communication apparatus supports wireless communication. However, each embodiment may be applied to a communication apparatus that supports wired communication instead of wireless communication, or a communication apparatus that supports both wireless communication and wired communication.

### First Embodiment

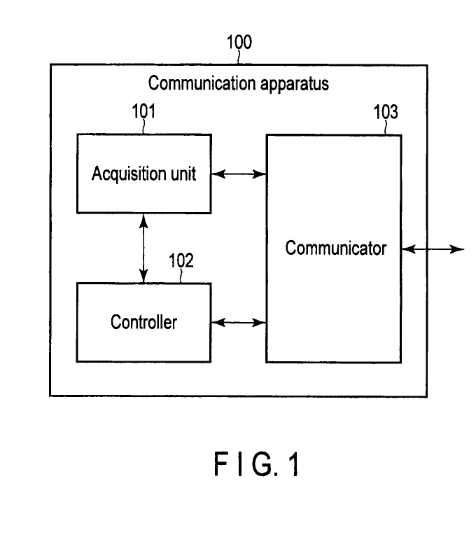

As exemplified in FIG. 1, a communication apparatus 100 according to the first embodiment includes an acquisition unit 101, a controller 102, and a communicator 103.

The acquisition unit 101 acquires, from the communicator 103, indices regarding the communication quality of each link in a network which the communication apparatus 100 joins, and saves the indices as communication quality information intact, or processes and saves the indices as communication quality information.

When, for example, the communication apparatus 100 performs wireless communication, the indices regarding the communication quality can include a reception power, a packet error rate, an SINR (Signal to Interference and Noise Ratio), a wireless communication connection state, and a TCP (Transmission Control Protocol) connection state.

The acquisition unit 101 may acquire and save the value of one of the indices as communication quality information intact, or may save the statistic (for example, the average) of the value of one of the acquired indices as communication quality information. Alternatively, the acquisition unit 101 may save the composite value (for example, the weighted sum) (or the statistic of the composite value) of the values of the plurality of acquired indices (or the statistics of the respective indices) as communication quality information. The acquisition unit 101 may integrate the pieces of communication quality information of a plurality of links, and save the integrated information. Note that practical examples of the communication quality information are not limited to them. The acquisition unit 101 outputs the communication quality information to the controller 102.

The acquisition unit 101 may also acquire preliminary master device information, and save the information. The preliminary master device information indicates at least whether another communication apparatus that can serve as a master device exists in the network which the communication apparatus 100 joins. For example, the preliminary master device information may be information indicating whether another communication apparatus that supports a master device mode (to be described later) exists in the network, or information indicating whether the corresponding communication apparatus supports the master device mode for each of the remaining communication apparatuses which join the network. The preliminary master device information may be fixed during the operation of the communication apparatus 100 or dynamically changed. The preliminary master device information may be acquired or created based on communication performed by the communicator 103, or saved in advance in a memory (not shown) storing setting information. The acquisition unit 101 may acquire the preliminary master device information from the communicator 103 or the memory.

The controller 102 receives the communication quality information from the acquisition unit 101. The controller 102 controls the operation mode of the communicator 103 based on the current operation mode of the communicator 103 and the communication quality information. More specifically, the controller 102 decides an appropriate operation mode. If the current operation mode of the communicator 103 is different from the appropriate operation mode, the controller 102 changes the operation mode of the communicator 103 to the appropriate operation mode. Note that the controller 102 may control the operation mode of the communicator 103 based on the preliminary master device information in addition to the current operation mode of the communicator 103 and the communication quality information. Control of the operation mode by the controller 102 will be described in detail later. When controlling the operation mode of the communicator 103, the controller 102 may reset the power supply of the communicator 103 or the memory connected to the communicator 103.

The communicator 103 supports a plurality of operation modes including at least a master device mode and a slave device mode. If the operation mode of the communicator 103 is the master device mode, the communication apparatus 100 functions as the hub of the network which the communication apparatus 100 joins. On the other hand, if the operation mode of the communicator 103 is the slave device mode, the communication apparatus 100 does not function as the hub of the network which the communication apparatus 100 joins.

As described above, the controller 102 controls the operation mode of the communicator 103. The communicator 103 transmits/receives a signal on the network which the communication apparatus 100 joins. The signal transmitted/received by the communicator 103 may depend on its operation mode.

If, for example, the communication apparatus 100 performs wireless communication, the communicator 103 may include an RF (Radio Frequency) unit, a transmission processor, a reception processor, and a link management unit.

The RF unit performs analog signal processing. More specifically, the RF unit may include a general analog signal processing circuit in wireless communication, such as an LNA (Low Noise Amplifier), MIX (MIXer), VCO (Voltage Controlled Oscillator), or PA (Power Amplifier).

The transmission processor performs baseband digital signal processing corresponding to processing of transmitting a control packet and data packet. More specifically, the transmission processor may append a CRC (Cyclic Redundancy Check) code, and perform encryption, noise whitening, and error correction encoding (for example, FEC (Forward Error Correction)).

The reception processor performs baseband digital signal processing corresponding to processing of receiving a control packet and data packet. More specifically, the reception processor may perform correlation detection, error correction decoding, inverse noise whitening, decryption, and error detection.

The link management unit manages a wireless link. The operation of the link management unit may depend on the operation mode of the communicator 103.

Note that although not shown in FIG. 1, the communication apparatus 100 may include a notification unit for notifying the outside of the current operation mode of the communicator 103. The notification unit includes, for example, a light emitting diode (LED), and the lighting pattern or flickering pattern of this LED or the brightness or color of light at the time of lighting or flickering is controlled according to the current operation mode of the communicator 103. If the communication apparatus 100 includes the notification unit, a user (for example, an administrator) can readily confirm the current operation mode of the communication apparatus 100 and the arrangement of the network to which the communication apparatus 100 belongs.

If the operation mode of the communicator 103 is the master device mode, the controller 102 may change the operation mode to the slave device mode under the condition that a change in communication quality information for a unit period satisfies a predetermined criterion. More specifically, if the communication qualities of a plurality of links degrade within a short period, it is appropriate to estimate that the communication failure has been caused by the communication apparatus 100 (master device) rather than the remaining communication apparatuses (slave devices). For example, if the total number of remaining communication apparatuses (slave devices) connected to the communication apparatus 100 (that is, the communicator 103) decreases by two or more for 1 sec, it is appropriate to estimate that the communication failure has been caused by the communication apparatus 100 (master device) rather than the remaining communication apparatuses (slave devices). Consequently, the controller 102 decides to set the operation mode of the communicator 103 to the slave device mode, and the communication apparatus 100 joins, as a slave device, a network reconstructed centered on a new master device.

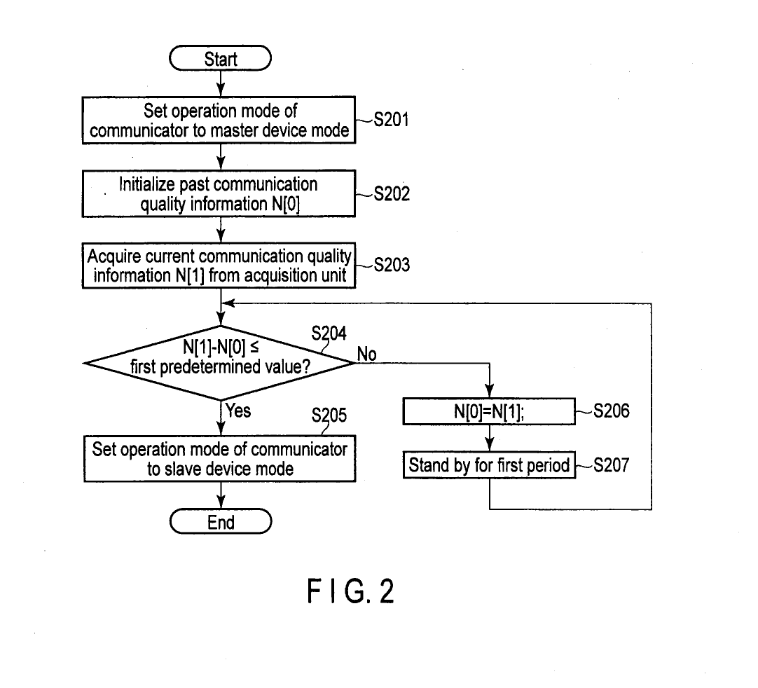

For example, the controller 102 may operate, as shown in FIG. 2. An operation shown in FIG. 2 starts after the controller 102 decides to set the operation mode of the communicator 103 to the master device mode.

Upon start of the operation shown in FIG. 2, the controller 102 sets the operation mode of the communicator 103 to the master device mode (step S201). The controller 102 initializes past communication quality information N[0] (step S202) where N[0] represents a variable or array for storing past communication quality information. After steps S201 and S202, the process advances to step S203. In the example shown in FIG. 2, the communication quality information may indicate the total number of links whose communication quality is equal to or higher than a threshold.

In step S203, the controller 102 acquires current communication quality information N[1] from the acquisition unit 101. If the difference between the past communication quality information N[0] and the current communication quality information N[1] is equal to or smaller than the first predetermined value, the process advances to step S205; otherwise, the process advances to step S206 (step S204).

In step S205, the controller 102 decides to set the operation mode of the communicator 103 to the slave device mode. The controller 102 may immediately set the operation mode of the communicator 103 to the slave device mode, or further perform processing as exemplified in FIG. 10.

Note that when setting the operation mode of the communicator 103 to the slave device mode, the controller 102 may reset the power supply of the communicator 103 or the memory connected to the communicator 103. When an abnormal operation or memory error occurs in the communicator 103, performing reset processing may improve the operation state of the communicator 103.

In step S206, the controller 102 substitutes the current communication quality information N[1] into the past communication quality information N[0]. Furthermore, the controller 102 stands by for the first period (step S207), and then the process returns to step S203.

That is, in the operation example shown in FIG. 2, when the change amount of the communication quality information for the first period is equal to or smaller than the first predetermined value, the controller 102 decides to set the operation mode of the communicator 103 to the slave device mode.

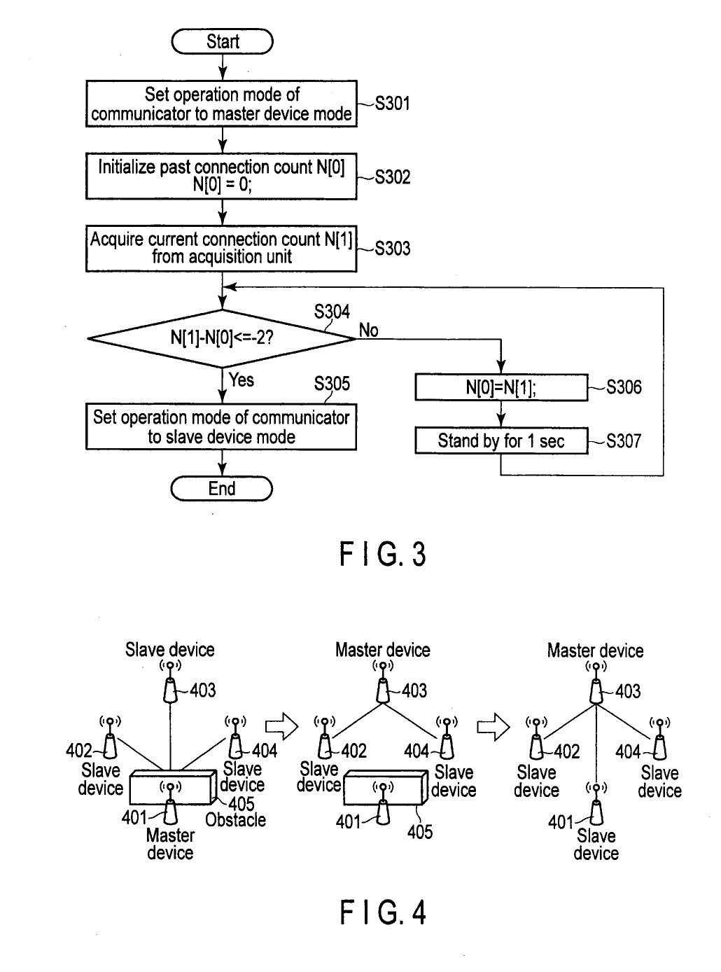

Alternatively, the controller 102 may operate as exemplified in FIG. 3. An operation shown in FIG. 3 starts after the controller 102 decides to set the operation mode of the communicator 103 to the master device mode. In an example shown in FIG. 3, the communication quality information indicates the total number (to be referred to as a connection count hereinafter) of communication apparatuses (slave devices) connected to the communication apparatus 100. Note that the connection state of a slave device can be defined using various criteria. If, for example, the reception power of a transmission signal from a slave device in the master device is equal to or higher than a threshold, it can be determined that the slave device is in the connection state. Alternatively, if the master device has not confirmed communication from a slave device for the second period, it can be determined that the slave device is not in the connection state.

Upon start of the operation shown in FIG. 3, the controller 102 sets the operation mode of the communicator 103 to the master device mode (step S301). The controller 102 initializes a past connection count N[0] (0 is substituted in the example shown in FIG. 3) (step S302) where N[0] represents, for example, a variable storing a past connection count. After steps S301 and S302, the process advances to step S303.

In step S303, the controller 102 acquires a current connection count N[1] from the acquisition unit 101. If the difference between the past connection count N[0] and the current connection count N[1] is equal to or smaller than −2 (this predetermined value may be changed to −3 or less), the process advances to step S305; otherwise, the process advances to step S306 (step S304).

In step S305, the controller 102 decides to set the operation mode of the communicator 103 to the slave device mode. At this time, the controller 102 may immediately set the operation mode of the communicator 103 to the slave device mode, or further perform processing as exemplified in FIG. 10.

In step S306, the controller 102 substitutes the current connection count N[1] into the past connection count N[0]. Furthermore, the controller 102 stands by for 1 sec (step S307), and then the process returns to step S303.

That is, in the operation example shown in FIG. 3, when the change amount of the connection count for 1 sec is equal to or smaller than −2, the controller 102 decides to set the operation mode of the communicator 103 to the slave device mode.

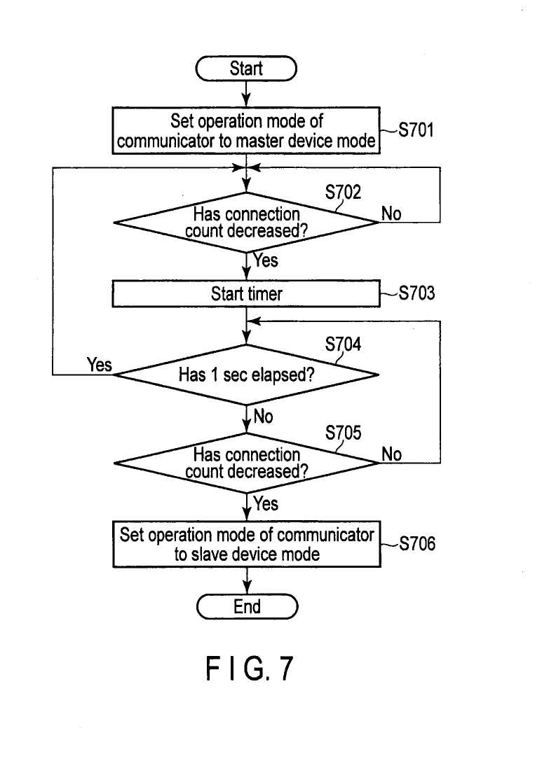

Note that the controller 102 may operate, as exemplified in FIG. 7 instead of FIG. 3. An operation shown in FIG. 7 starts after the controller 102 decides to set the operation mode of the communicator 103 to the master device mode. In an example shown in FIG. 7, the communication quality information indicates the connection count.

Upon start of the operation shown in FIG. 7, the controller 102 sets the operation mode of the communicator 103 to the master device mode (step S701). It is then repeatedly determined in step S702 whether the connection count has decreased as compared with that when step S702 was executed last time. If a decrease in connection count is determined in step S702, the process advances to step S703.

In step S703, the controller 102 starts a timer. If the connection count decreases again with respect to the connection count determined in step S702 before the timer measures 1 sec, the process advances to step S706 (steps S704 and S705). On the other hand, if the connection count does not decrease again as compared with that determined in step S702 while the timer measures 1 sec, the process returns to step S702 (steps S704 and S705).

In step S706, the controller 102 decides to set the operation mode of the communicator 103 to the slave device mode. At this time, the controller 102 may immediately set the operation mode of the communicator 103 to the slave device mode, or further perform processing as exemplified in FIG. 10.

That is, in the operation example shown in FIG. 7, when the connection count decreases by two or more for 1 sec, the controller 102 decides to set the operation mode of the communicator 103 to the slave device mode.

According to the operation example shown in FIG. 2, 3, or 7, the communication system including the communication apparatus according to the first embodiment operates as exemplified in FIG. 4.

In an example shown in FIG. 4, at least a communication apparatus 401 is an apparatus according to this embodiment. Communication apparatuses 402, 403, and 404 serving as slave devices are connected to the communication apparatus 401 serving as a master device. When an obstacle 405 temporarily appears around the communication apparatus 401, the communication qualities between the communication apparatus 401 and the communication apparatuses 402, 403, and 404 temporarily degrade. Consequently, the controller of the communication apparatus 401 decides to set the operation mode of a communicator to the slave device mode.

By using, as a trigger, the fact that it is impossible to receive a signal (for example, a beacon frame, an Alive message, or the like) expected to be transmitted by the communication apparatus 401 serving as a master device, each of the communication apparatuses 402, 403, and 404 detects a communication failure of the master device. Note that the communication apparatuses 402, 403, and 404 are designed to reconstruct a new network by causing one of the communication apparatuses 402, 403, and 404 to operate as a new master device in such case. In the example shown in FIG. 4, the communication apparatus 403 operates as a new master device, thereby reconstructing a new network centered on the communication apparatus 403.

Since the communication apparatus 401 operates as a slave device instead of an isolated master device, it can be connected to the communication apparatus 403 serving as the current master device when the obstacle 405 disappears. That is, the communication apparatus 401 can join, as a slave device, the new network centered on the communication apparatus 403.

Note that a communication apparatus to serve as a new master device when a communication failure occurs in the current master device may be selected based on the suitability of each communication apparatus as a master device, which has been evaluated by various methods before the occurrence of the communication failure. For example, a communication apparatus to serve as a new master device may be selected based on the capability of each communication apparatus. Alternatively, a communication apparatus to serve as a new master device may be selected according to various standards such as a minimax standard based on the communication quality (for example, the reception power) of each link between communication apparatuses in the network.

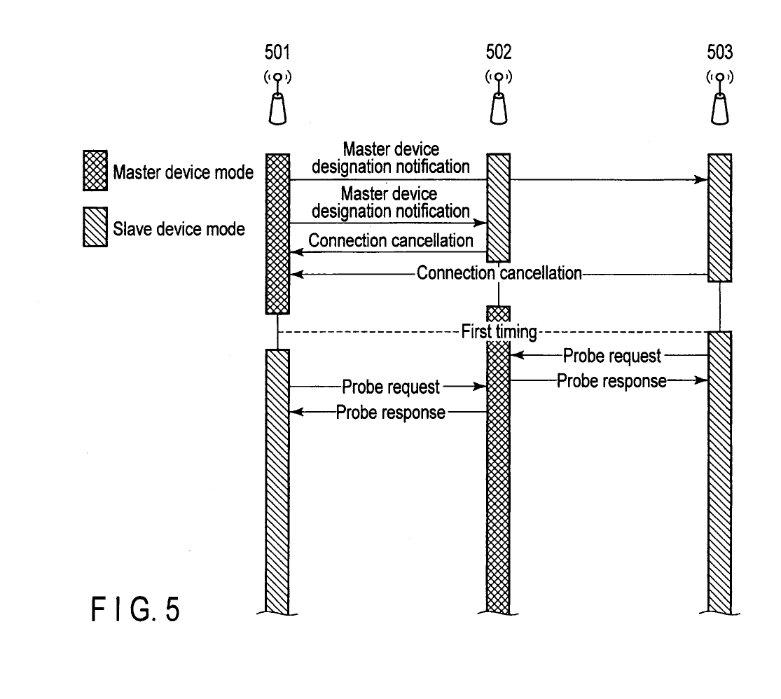

Furthermore, the communication apparatus serving as the current master device may transfer the authority of the master device to the selected communication apparatus when it operates in the slave device mode. FIG. 5 shows an example of this operation.

In the example of FIG. 5, at least a communication apparatus 501 is an apparatus according to this embodiment. Communication apparatuses 502 and 503 serving as slave devices are connected to the communication apparatus 501 serving as a master device. For some reason, the controller of the communication apparatus 501 decides to set the operation mode of a communicator to the slave device mode. The controller transmits (for example, broadcasts), to the communication apparatuses 502 and 503, a master device designation notification indicating that the communication apparatus 502 has been designated as a new master device (that is, a communication apparatus to which the authority of the master device is to be transferred). The master device designation notification may contain information (for example, a unique identifier) for identifying the designated communication apparatus.

Upon receiving the master device designation notification, each of the communication apparatuses 502 and 503 cancels connection to the communication apparatus 501 serving as the master device. Furthermore, the communication apparatus 502 designated as a new master device by the master device designation notification changes its operation mode to the master device mode. On the other hand, the communication apparatus 503 which has not been designated as a new master device by the master device designation notification changes the connection destination to the communication apparatus 502 serving as the new master device. More specifically, the communication apparatus 503 is connected to the communication apparatus 502 at an appropriate timing. The communication apparatus 501 newly operating in the slave device mode is also connected to the communication apparatus 502 at an appropriate timing.

Note that in the example shown in FIG. 5, a wireless LAN is reconstructed without changing an SSID (Service Set IDentifier). Each of the communication apparatuses 501 and 503 exchanges a probe request frame and probe response frame to connect to the communication apparatus 502. According to this technique, since a slave device is connected to a master device corresponding to the transmission source of a probe response frame, it is not preferable to transmit a probe request frame in an environment in which a plurality of master devices (communication apparatuses each of which may serve as the transmission source of a probe response frame) coexist. Therefore, each of the communication apparatuses 501 and 503 desirably transmits a probe request frame after a timing (the first timing in the example shown in FIG. 5) at which the operation mode of the communication apparatus 502 is the master device mode and the operation mode of each of the remaining communication apparatuses is the slave device mode.

An operation of transferring the authority of the master device is not limited to the example shown in FIG. 5. It is only necessary to finally reconstruct a network centered on a new master device. For example, the master device designation notification may be broadcast by the slave device instead of the master device. The slave device may designate the unique identifier of the new master device to perform connection processing, or exchange messages for authentication processing or connection processing in addition to the probe request frame and probe response frame.

When selecting a communication apparatus to serve as a new master device as described above, candidates each having the second or subsequent suitability as a master device may be selected together. By sharing information about the second and subsequent candidates among the communication apparatuses in the network, the authority of the master device is taken over in an appropriate order when a second or subsequent communication failure occurs.

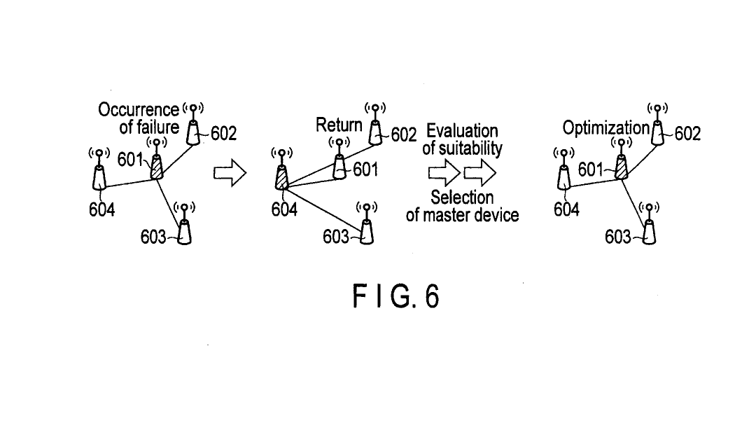

Alternatively, the suitability of each communication apparatus as a master device may be continuously (for example, periodically) evaluated. With this operation, it is possible to appropriately update information of a communication apparatus to serve as a new master device even in an environment in which the communication quality readily changes. Furthermore, if continuous evaluation results in the presence of a communication apparatus having suitability higher than that of the current master device, the authority of the master device may be transferred to another slave device, or returned to the past master device, as exemplified in FIG. 6. This operation can improve the reliability (especially, fault tolerance) by continuously adapting the network to the communication environment.

In an example shown in FIG. 6, at least communication apparatuses 601 and 604 are apparatuses according to this embodiment. Communication apparatuses 602, 603 and 604 all of which serve as slave devices are connected to the communication apparatus 601 serving as a master device. If, for some reason, the controller of the communication apparatus 601 decides to set the operation mode of a communicator to the slave device mode, it transfers the authority of the master device to the communication apparatus 604 having the highest suitability as a master device.

When the communication apparatus 604 starts operating as a new master device, a network is reconstructed centered on the communication apparatus 604. The communication apparatus 601 which has newly started operating as a slave device in addition to the communication apparatuses 602 and 603 is connected to the communication apparatus 604.

If the result of continuously evaluating the suitability indicates that the suitability of the communication apparatus 601 exceeds that of the communication apparatus 604, the communication apparatus 604 returns the authority of the master device to the communication apparatus 601. When the communication apparatus 601 starts operating as a master device again, a network is reconstructed centered on the communication apparatus 601. The communication apparatus 604 which has started operating as a slave device again in addition to the communication apparatuses 602 and 603 is connected to the communication apparatus 601.

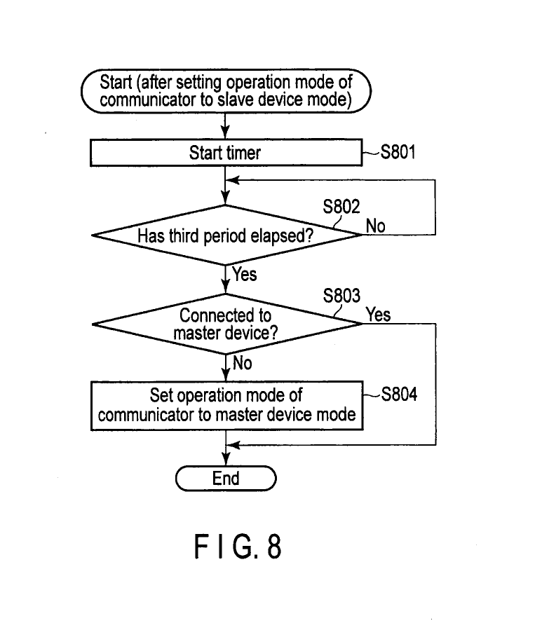

Even if the communication apparatus 100 operates as exemplified in FIG. 2, 3, or 7, and the operation mode of the communicator 103 is set to the slave device mode, none of the remaining communication apparatuses can serve as a master device, resulting in the absence of a master device. In this case, the communication apparatus 100 may return as a master device. FIG. 8 shows an example of the operation.

The operation shown in FIG. 8 starts after the controller 102 sets the operation mode of the communicator 103 to the slave device mode. Upon start of the operation shown in FIG. 8, the controller 102 starts the timer (step S801). When the timer measures the third period, if the communication apparatus 100 is connected to a new master device, the process of FIG. 8 ends (steps S802 and S803). On the other hand, when the timer measures the third period, if the communication apparatus 100 is not connected to the new master device, the process advances to step S804 (steps S802 and S803). In step S804, the controller 102 sets the operation mode of the communicator 103 to the master device mode. As a result, the communication apparatus 100 returns as a master device, thereby reconstructing a network.

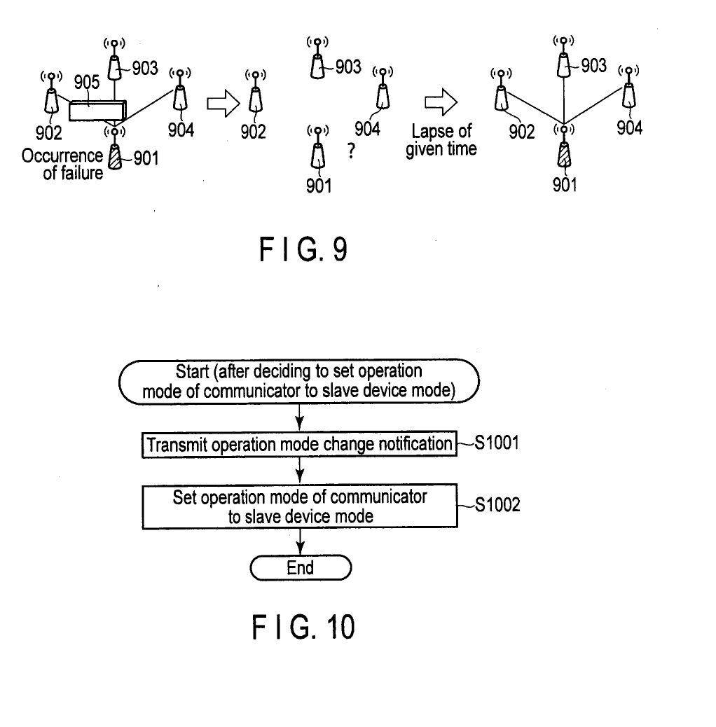

In the operation example shown in FIG. 8, the communication system including the communication apparatus according to the first embodiment operates as exemplified in FIG. 9.

In an example shown in FIG. 9, at least a communication apparatus 901 is an apparatus according to this embodiment. Communication apparatuses 902, 903, and 904 serving as slave devices are connected to the communication apparatus 901 serving as a master device. If an obstacle 905 temporarily appears around the communication apparatus 901, the communication qualities between the communication apparatus 901 and the communication apparatuses 902, 903, and 904 temporarily degrade. Consequently, the controller of the communication apparatus 901 decides to set the operation mode of a communicator to the slave device mode.

By using, as a trigger, the fact that it is impossible to receive a signal expected to be transmitted by the communication apparatus 901 serving as the master device, each of the communication apparatuses 902, 903, and 904 detects a communication failure of the master device. Assume, however, that none of the communication apparatuses 902, 903, and 904 can serve as a master device for some reason. In this case, no master device exists and thus the network temporarily disappears.

If the network disappears, the communication apparatus 901 cannot be connected to a master device. Then, if this state is not resolved even when the third period elapses after the controller of the communication apparatus 901 starts a timer, the controller sets the operation mode of the communicator of the communication apparatus 901 to the master device mode.

By setting the operation mode of the communicator of the communication apparatus 901 to the master device mode, the communication apparatus 901 returns as a master device. As a result, a network is reconstructed centered on the communication apparatus 901. In the operation example shown in FIG. 9, if the obstacle 905 disappears before the communication apparatus 901 returns as a master device, it is possible to normally perform communication on the reconstructed network.

As described above, after deciding the operation mode of the communicator 103 to the slave device mode, the controller 102 may immediately set the operation mode of the communicator 103 to the slave device mode, or further perform processing as exemplified in FIG. 10.

An operation shown in FIG. 10 starts after the controller 102 decides to set the operation mode of the communicator 103 to the slave device mode. Upon start of the operation shown in FIG. 10, the controller 102 causes the communicator 103 to transmit (for example, broadcast), to the remaining communication apparatuses, an operation mode change notification indicating that the operation mode of the communicator 103 is to be changed (step S1001). Upon receiving the operation mode change notification, the remaining communication apparatuses detect disappearance of the master device, and reconstruct a network (that is, each of the remaining communication apparatuses starts an operation as a new master device or attempts to connect to the new master device). The controller 102 sets the operation mode of the communicator 103 to the slave device mode (step S1002). In the operation example shown in FIG. 10, since the remaining communication apparatuses can detect disappearance of the master device at an early stage, a period during which the remaining communication apparatuses are not connected to a master device (that is, a period required to reconstruct a network) is shortened. Note that when the connection count of the communication apparatus 100 is 0, the remaining communication apparatuses receive no operation mode change notification. Therefore, in this case, the operation example shown in FIG. 10 may be modified so that the processing in step S1001 is omitted.

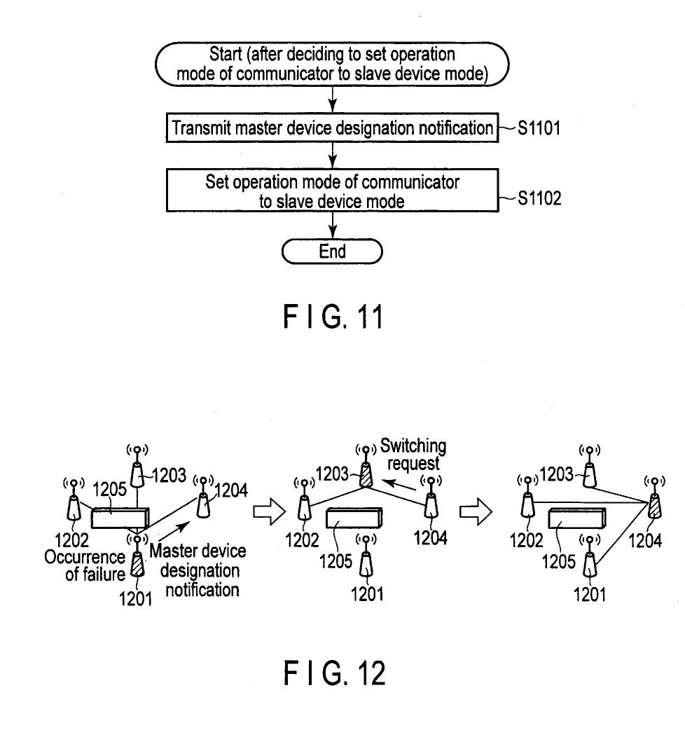

Alternatively, after deciding the operation mode of the communicator 103 to the slave device mode, the controller 102 may operate as exemplified in FIG. 11.

An operation shown in FIG. 11 starts after the controller 102 decides to set the operation mode of the communicator 103 to the slave device mode. Upon start of the operation shown in FIG. 11, the controller 102 causes the communicator 103 to transmit (for example, broadcast) a master device designation notification to the remaining communication apparatuses (step S1101). This master device designation notification contains information (for example, a unique identifier) for identifying a communication apparatus designated as a new master device. Upon receiving the master device designation notification, the remaining communication apparatuses detect disappearance of the master device, and reconstruct a network. More specifically, the communication apparatus designated as the next master device in the master device designation notification starts operating as a new master device, and the communication apparatuses which have not been designated as a new master device in the master device designation notification attempt to connect to the new master device. The controller 102 sets the operation mode of the communicator 103 to the slave device mode (step S1102). In the operation example shown in FIG. 11, since the roles of the remaining communication apparatuses in the next network become apparent, the period required to reconstruct a network is shortened.

In the operation example shown in FIG. 11, the communication apparatus designated as the new master device in the master device designation notification may be selected from the communication apparatuses connected to the communication apparatus 100. Information for identifying the remaining communication apparatuses connected to the communication apparatus 100 may be acquired by the acquisition unit 101, and input to the controller 102. When the communication apparatus serves as a new master device, all the communication apparatuses in the network may be able to communicate with each other again. The communication system including the communication apparatus according to the first embodiment may operate as shown in FIG. 12.

In an example shown in FIG. 12, at least a communication apparatus 1201 is an apparatus according to this embodiment. Communication apparatuses 1202, 1203, and 1204 serving as slave devices are connected to the communication apparatus 1201 serving as a master device. When an obstacle 1205 temporarily appears around the communication apparatus 1201, the communication qualities between the communication apparatus 1201 and the communication apparatuses 1202 and 1203 temporarily degrade. Consequently, the controller of the communication apparatus 1201 decides to set the operation mode of a communicator to the slave device mode. The communication apparatus 1201 selects a new master device from the communication apparatuses connected to the communication apparatus 1201. More specifically, the communication apparatus 1201 broadcasts a master device designation notification for designating the communication apparatus 1204 as a new master device.

Upon receiving the master device designation notification, the communication apparatus 1204 starts operating as a master device. Note that as shown in FIG. 12, if the other communication apparatus 1203 already operates as a master device, the communication apparatus 1204 may issue a master device switching request so as to obtain the authority of the master device from the other communication apparatus 1203. In order to detect that the communication apparatus 1203 is operating as a master device, the communication apparatus 1204 may operate as a slave device for a predetermined period before starting operating as a master device. If the slave device connection count does not reach an expected number after starting operating as a master device, the communication apparatus 1204 may transfer the authority of the master device to another communication apparatus (for example, the communication apparatus 1203) while changing the operation mode to the slave device mode.

When the communication apparatus 1204 operates as a new master device, all the communication apparatuses 1201, 1202, 1203, and 1204 in the network can communicate with each other again by avoiding the obstacle 1205.

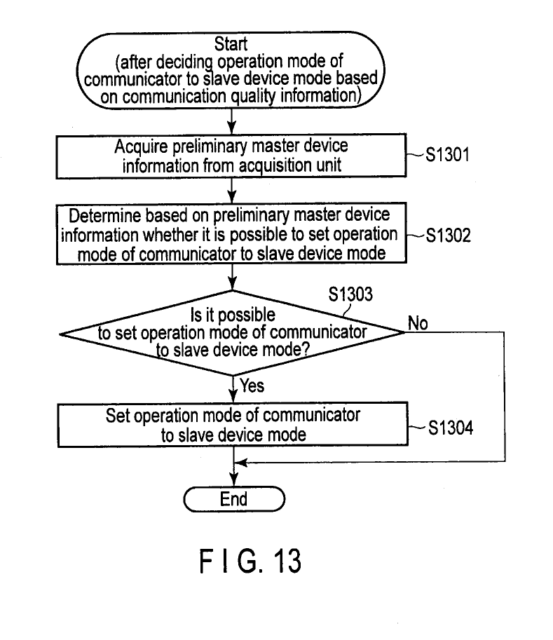

In the operation example shown in FIG. 2, 3, or 7 described above, based on the communication quality information, the controller 102 decides whether to set the operation mode of the communicator 103 to the slave device mode. As described above, the controller 102 may control the operation mode of the communicator 103 based on the preliminary master device information in addition to the communication quality information. FIG. 13 shows an example of this operation.

The operation shown in FIG. 13 starts after the controller 102 decides to set the operation mode of the communicator 103 to the slave device mode based on the communication quality information. Upon start of the operation shown in FIG. 13, the controller 102 acquires the preliminary master device information from the acquisition unit 101 (step S1301). Based on the preliminary master device information, the controller 102 determines whether it is possible to set the operation mode of the communicator 103 to the slave device mode (step S1302). If the preliminary master device information indicates that, for example, another communication apparatus which supports the master device mode exists in the network, the controller 102 may determine in step S1302 that it is possible to set the operation mode of the communicator 103 to the slave device mode.

If it is determined in step S1302 that it is possible to set the operation mode of the communicator 103 to the slave device mode, the process advances to step S1304 (step S1303). On the other hand, if it is determined in step S1302 that it is impossible to set the operation mode of the communicator 103 to the slave device mode, the process of FIG. 13 ends (step S1303). That is, the operation mode of the communicator 103 is maintained to be the master device mode. In step S1304, the controller 102 decides again to set the operation mode of the communicator 103 to the slave device mode. In this case, the controller 102 may immediately set the operation mode of the communicator 103 to the slave device mode, or further perform processing as exemplified in FIG. 10.

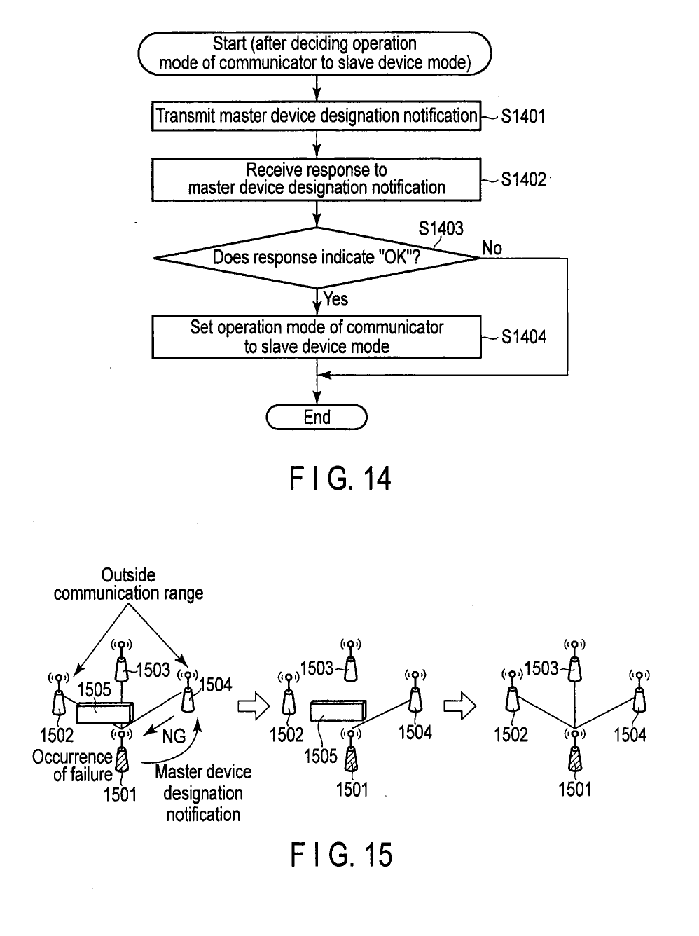

In the operation example of FIG. 11 described above, it is not ensured that the communication apparatus designated as a new master device in the master device designation notification serves as a master device. If, therefore, the communication apparatus designated as a new master device in the master device designation notification cannot serve as a master device, no master device may exist. To avoid such situation, whether the communication apparatus designated as a new master device in the master device designation notification can serve as a master device may be determined in advance based on the preliminary master device information or determined based on a response to the master device designation notification from the communication apparatus or another communication apparatus, as exemplified in FIG. 14.

An operation shown in FIG. 14 starts after the controller 102 decides to set the operation mode of the communicator 103 to the slave device mode. Upon start of the operation shown in FIG. 14, the controller 102 causes the communicator 103 to transmit (for example, broadcast) a master device designation notification to the remaining communication apparatuses (step S1401).

Upon receiving the master device designation notification, each of the remaining communication apparatuses replies a response message to the master device designation notification. The response may indicate that the communication apparatus designated as a new master device in the master device designation notification can serve as a master device (OK) or indicate that the communication apparatus cannot serve as a master device (NG). For example, the response indicating “NG” may be replied when another communication apparatus exists outside the communication range of the designated communication apparatus in the network, when the designated communication apparatus does not support the master device mode, when the designated communication apparatus has no Internet connection capability, or when the designated communication apparatus lacks another function. Instead of the communication apparatus designated as a new master device, another communication apparatus having information about the designated communication apparatus may reply a response.

In step S1402, the communicator 103 receives the response to the master device designation notification, which has been transmitted in step S1401. If the response received in step S1402 indicates “OK”, the process advances to step S1404. On the other hand, if the response received in step S1402 does not indicate “OK”, the process of FIG. 14 ends. That is, the operation mode of the communicator 103 is maintained to be the master device mode. In step S1404, the controller 102 sets the operation mode of the communicator 103 to the slave device mode.

In the operation example shown in FIG. 14, the communication system including the communication apparatus according to the first embodiment operates as exemplified in FIG. 15.

In an example shown in FIG. 15, at least a communication apparatus 1501 is an apparatus according to this embodiment. Communication apparatuses 1502, 1503, and 1504 serving as slave devices are connected to the communication apparatus 1501 serving as a master device. When an obstacle 1505 temporarily appears around the communication apparatus 1501, the communication qualities between the communication apparatus 1501 and the communication apparatuses 1502 and 1503 temporarily degrade. Consequently, the controller of the communication apparatus 1501 decides to set the operation mode of a communicator to the slave device mode.

The communication apparatus 1501 broadcasts a master device designation notification for designating the communication apparatus 1504 as a new master device. Since, however, the other communication apparatus 1502 exists outside the communication range of the communication apparatus 1504 in the network, the communication apparatus 1504 transmits a response indicating “NG” to the communication apparatus 1501. As a result, the communication apparatus 1501 continues operating as a master device. In the example of FIG. 15, the communication apparatuses other than the communication apparatus 1504 are not connected to the communication apparatus 1501, and thus the communication apparatuses 1501 and 1504 communicate with each other.

When the obstacle 1505 disappears, the communication apparatuses 1502 and 1503 can be connected to the communication apparatus 1501 again. Consequently, the network centered on the communication apparatus 1501 recovers.

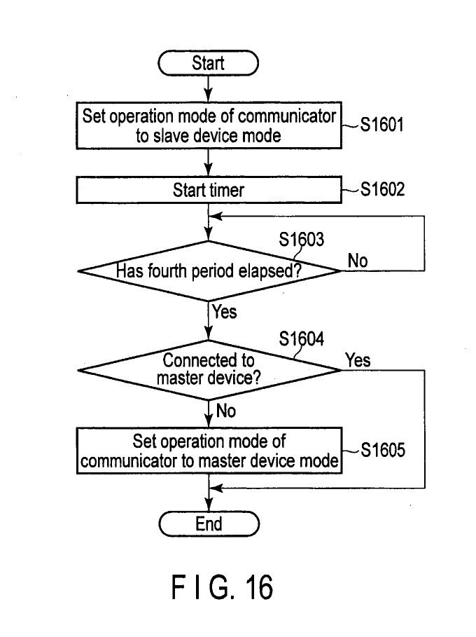

In the above-described various operation examples, a description has been given by assuming the default operation mode of the communication apparatus according to the embodiment is the master device mode. However, the default operation mode of the communication apparatus may be the slave device mode. If, for example, the default operation mode of the communication apparatus 100 is the slave device mode, the communication apparatus 100 may operate as exemplified in FIG. 16. An operation shown in FIG. 16 may start upon power-on of the communicator 103.

Upon start of the operation shown in FIG. 16, the controller 102 sets the operation mode of the communicator 103 to the slave device mode (step S1601). Furthermore, the controller 102 starts the timer (step S1602). When the timer measures the fourth period, if the communication apparatus 100 is connected to a master device, the process of FIG. 16 ends (steps S1603 and S1604). On the other hand, when the timer measures the fourth period, if the communication apparatus 100 is not connected to the master device, the process advances to step S1605 (steps S1603 and S1604). In step S1605, the controller 102 sets the operation mode of the communicator 103 to the master device mode.

If, for example, a plurality of communication apparatuses according to this embodiment operate as shown in FIG. 16 when constructing a network using these communication apparatuses for the first time, the first activated communication apparatus automatically serves as a master device, and the second and subsequent activated communication apparatuses automatically serve as slave devices. Therefore, since part of a procedure necessary to construct a network for the first time is automated, the labor of the operation is reduced. This effect can be obtained not only when a network is constructed for the first time but also when, for example, an additional communication apparatus is newly arranged in the existing network or a communication apparatus in the existing network returns from an operation stop state caused by a power failure.

In the operation example shown in FIG. 16, the process branches depending on whether the communication apparatus 100 is connected to the master device when the timer measures the fourth period (steps S1603 and S1604). This operation example, however, may be modified, as will be described below.

The timer measures the fifth period shorter than the fourth period. When the timer measures the fifth period, the controller 102 determines whether the communication apparatus 100 is connected to the master device. If the communication apparatus 100 is connected to the master device, the process ends; otherwise, the controller 102 increments or decrements the counter. If the count value satisfies a predetermined criterion, the controller 102 sets the operation mode of the communicator 103 to the master device mode; otherwise, the controller 102 restarts the timer. The predetermined criterion may indicate that the count value coincides with a value representing that the timer repeatedly measures the fifth period a predetermined number of times (for example, a quotient obtained by dividing the fourth period by the fifth period).

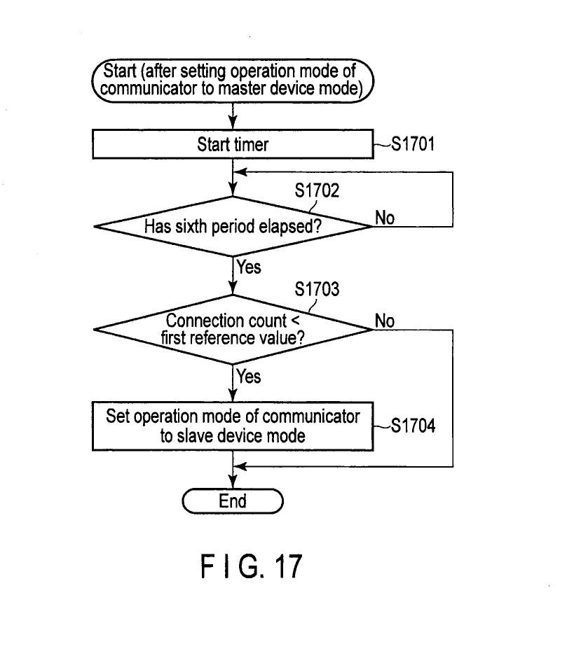

When a communication failure estimated to be caused by the communication apparatus according to the embodiment is detected based on the communication quality information while the communication apparatus operates as a master device, the remaining communication apparatuses reconstruct a network. However, if a plurality of master devices simultaneously appear at the time of reconstruction of a network, the network may be dissolved, resulting in too many small-scale networks. In this case, it is desirable to reconstruct a network on an expected scale by consolidating the small-scale networks. More specifically, when the communication apparatus 100 operates as exemplified in FIG. 17, consolidation of the small-scale networks is accelerated.

An operation shown in FIG. 17 starts after the controller 102 sets the operation mode of the communicator 103 to the master device mode. Upon start of the operation shown in FIG. 17, the controller 102 starts the timer (step S1701). When the timer measures the sixth period, if the connection count of the communication apparatus 100 is smaller than the first reference value, the process advances to step S1704 (steps S1702 and S1703). When the timer measures the sixth period, if the connection count of the communication apparatus 100 is equal to or larger than the first reference value, the process of FIG. 17 ends. That is, the operation mode of the communicator 103 is maintained to be the master device mode.

The first reference value is set to about half the expected connection count of the network. The expected connection count of the network may be derived by subtracting 1 from the total number of communication apparatuses which joined the network before occurrence of a communication failure, or set in advance by the acquisition unit 101 or the like. Note that if the first reference value is too large, not only a small-scale network but also a relatively large-scale network is dissolved, and the number of communication apparatuses which cannot temporarily communicate is unnecessarily increased, resulting in inefficient processing. On the other hand, if the first reference value is too small, the small-scale networks are difficult to be dissolved, resulting in inefficient processing.

In step S1704, the controller 102 decides to set the operation mode of the communicator 103 to the slave device mode. The controller 102 may immediately set the operation mode of the communicator 103 to the slave device mode, or further perform processing as exemplified in FIG. 10.

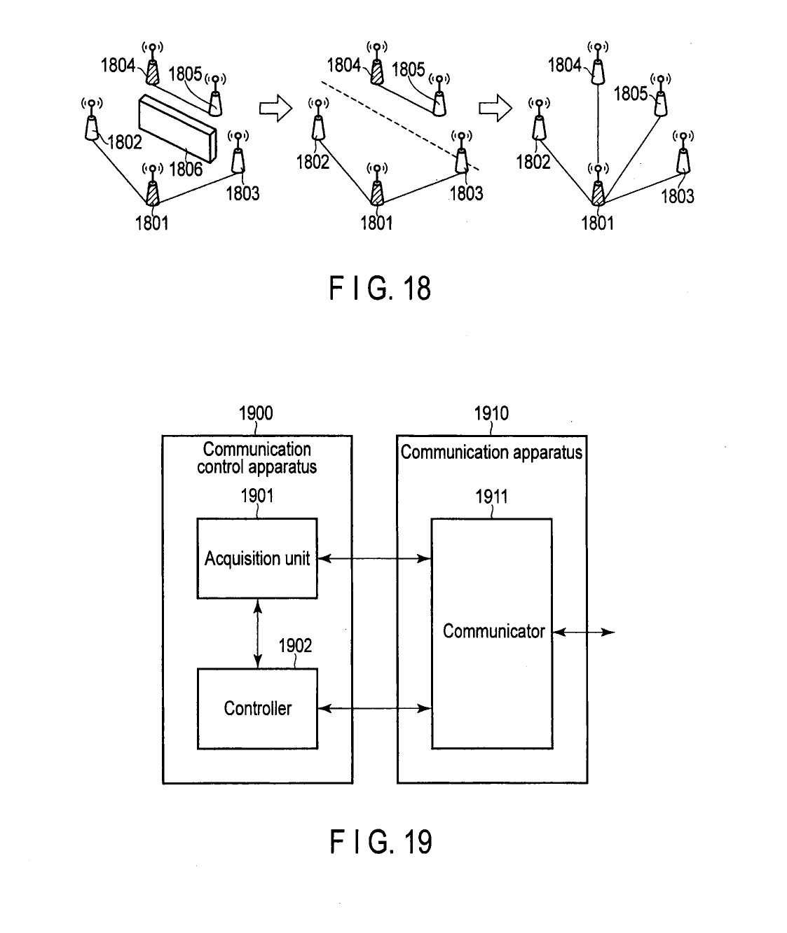

In the operation example shown in FIG. 17, the communication system including the communication apparatus according to the embodiment operates as exemplified in FIG. 18.

In an example shown in FIG. 18, at least communication apparatuses 1801 and 1804 are apparatuses according to this embodiment. The communication apparatus 1801, communication apparatuses 1802 and 1803, the communication apparatus 1804, and a communication apparatus 1805 joined a network (not shown), but the network has been dissolved due to the appearance of an obstacle 1806. After the network is dissolved, the communication apparatuses 1801 and 1804 become master devices, and networks centered on the respective master devices coexist.

In the example shown in FIG. 18, since the total number of communication apparatuses which joined the network before occurrence of a communication failure is five, the expected connection count can be derived as 4 (=5−1). The first reference value is set to 2 corresponding to half the expected connection count. The connection count =2 of the communication apparatus 1801 is equal to or larger than the first reference value but the connection count =1 of the communication apparatus 1804 is smaller than the first reference value. Therefore, the communication apparatus 1801 continues operating as a master device but the communication apparatus 1804 newly starts operating as a slave device.

When the obstacle 1806 disappears, the communication apparatuses 1804 and 1805 can be connected to the communication apparatus 1801. The two networks respectively centered on the communication apparatuses 1801 and 1804 are finally consolidated into a network centered on communication apparatus 1801.

As described above, if the operation mode of the communicator is the master device mode, the communication apparatus according to the first embodiment changes the operation mode to the slave device mode under the condition that a change in communication quality information for a unit period satisfies a predetermined criterion. That is, when a communication failure estimated to be caused by the communication apparatus occurs, the communication apparatus can promote reconstruction of a new network, and automatically join the reconstructed network as a slave device. This communication apparatus can, therefore, improve the reliability (especially, fault tolerance) of the network.

### Second Embodiment

In the above-described first embodiment, the communicator for performing communication and the acquisition unit and controller for controlling the communicator are arranged in the same apparatus. The acquisition unit and controller, however, may be arranged in an apparatus different from that including the communicator.

As exemplified in FIG. 19, a communication system according to the second embodiment includes a communication control apparatus 1900 and a communication apparatus 1910. The communication control apparatus 1900 includes an acquisition unit 1901 which may be the same as or similar to the acquisition unit 101 shown in FIG. 1, and a controller 1902 which may be the same as or similar to the controller 102 shown in FIG. 1. The communication control apparatus 1900 may further include a communication interface (not shown) for communicating with the outside. The communication apparatus 1910 includes a communicator 1911 corresponding to the communicator 103 shown in FIG. 1.

In FIG. 19, the communication control apparatus 1900 controls the one communication apparatus 1910. However, the communication control apparatus 1900 may centrally control a plurality of communication apparatuses, including the communication apparatus 1910.

In the communication system exemplified in FIG. 19, there is a low possibility that both the communication control apparatus 1900 and the communication apparatus 1910 will simultaneously fail due to a power supply failure or the like. Furthermore, if the communication apparatus 1910 fails and the communication control apparatus 1900 normally operates, the communication control apparatus 1900 can cause the communication apparatus 1910 to normally operate by externally detecting the failure of the communication apparatus 1910.

As described above, in the communication system according to the second embodiment, the acquisition unit and controller which are the same as or similar to those included in the communication apparatus according to the above-described first embodiment are arranged in the communication control apparatus which is independent of the communication apparatus. Therefore, the communication system can improve the reliability (especially, fault tolerance) of the network, similarly to the communication apparatus according to the first embodiment.

### Third Embodiment

The communication apparatus according to the first embodiment and the communication system according to the second embodiment are applicable to an energy management apparatus such as a smart meter.

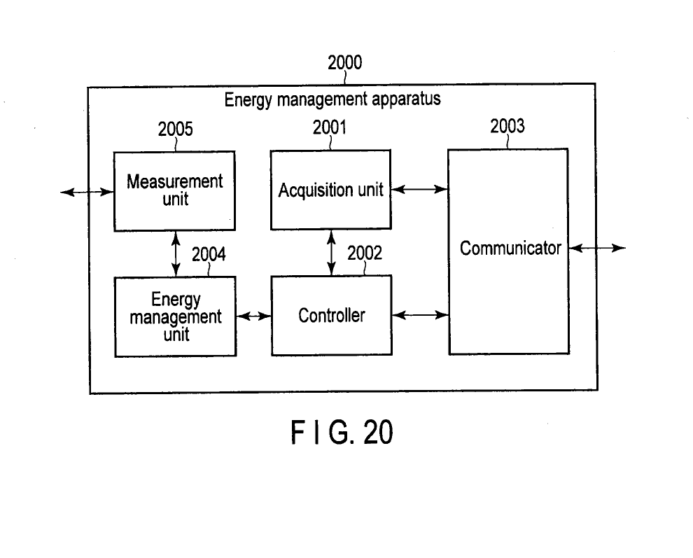

As shown in FIG. 20, an energy management apparatus 2000 according to the third embodiment includes an acquisition unit 2001, a controller 2002, a communicator 2003, an energy management unit 2004, and a measurement unit 2005. The acquisition unit 2001, controller 2002, and communicator 2003 may be the same as or similar to the acquisition unit 101, controller 102, and communicator 103 of FIG. 1, respectively.

The measurement unit 2005 obtains measurement data by measuring at least one physical quantity with respect to at least one kind of energy based on sensing data from a sensor or sensing device (not shown). For example, the measurement unit 2005 may measure the power consumption, generated power amount, or accumulated power amount for electricity, or measure a flow rate for water or gas.

The energy management unit 2004 manages the above-described measurement data. More specifically, the energy management unit 2004 manages the measurement data based on the logical or physical network arrangement among a plurality of energy management apparatuses.

The logical network arrangement indicates the relationship between the plurality of energy management apparatuses for hierarchically managing the measurement data. A given energy management apparatus may be able to directly communicate with an energy management apparatus positioned at an upper level in the logical network arrangement, or need to communicate with the energy management apparatus via one or more other energy management apparatuses. On the other hand, the physical network arrangement indicates the relationship (for example, master device—slave device) between the plurality of energy management apparatuses for exchanging the measurement data.

For example, the energy management unit 2004 may request the controller 2002 to externally transmit the measurement data. Upon receiving the request to transmit the measurement data from the energy management unit 2004, the controller 2002 requests the communicator 2003 to transmit the measurement data. Note that the controller 2002 adjusts the transmission timing in accordance with the state of the network. More specifically, the controller 2002 may temporarily buffer, in a memory (not shown), the measurement data which has been requested to be transmitted before a network is constructed. Then, the controller 2002 may request the communicator 2003 to transmit the measurement data buffered in the memory after the network is constructed. For example, “before the network is constructed” corresponds to a period during which the connection count of the energy management apparatus 2000 is equal to or smaller than a predetermined number (for example, the above-described expected connection count) when the operation mode of the communicator 2003 is the master device mode, and a period during which the energy management apparatus 2000 is not connected to a master device when the operation mode of the communicator 2003 is the slave device mode.

The controller 2002 may predict the probability (that is, the communication occurrence probability) that the energy management unit 2004 requests to transmit the measurement data. While the probability is equal to or lower than a threshold, the controller 2002 may sense the communication quality of each link in the network, or reconstruct a network (that is, the controller 2002 may change the operation mode of the communicator 2003). This operation can reduce the influence of sensing of the communication quality and reconstruction of the network on the measurement data traffic.

Furthermore, the controller 2002 may perform evaluation so that an energy management apparatus with a larger measurement data traffic amount has higher suitability as a master device when selecting an energy management apparatus to serve as a new master device. For example, the controller 2002 may acquire the type of measurement data managed by the energy management unit of each energy management apparatus, a measurement frequency by the measurement unit of each energy management apparatus, and the like by communication, and estimate in advance the measurement data traffic amount in each energy management apparatus based on the acquired data. Since an energy management apparatus whose measurement data traffic amount is large corresponds to a hub in a logical network with a high probability, it is possible to improve the efficiency of the traffic in the network by causing the energy management apparatus to function as a hub in a physical network as well as the logical network (that is, by making the physical network arrangement more similar to the logical network arrangement).

As described above, the energy management apparatus according to the third embodiment includes the acquisition unit and controller which are the same as or similar to those included in the communication apparatus according to the above-described first embodiment, respectively. Therefore, the energy management apparatus can improve the reliability (especially, fault tolerance) of the network, similarly to the communication apparatus according to the first embodiment and the communication system according to the second embodiment.

At least a part of the processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communicator that, when an operation mode is a first mode, functions as a hub of a network to communicate with another communication apparatus in the network, and when the operation mode is a second mode, communicates with another communication apparatus in the network without functioning as the hub of the network;
an acquisition unit configured to acquire communication quality information indicating a communication quality of each link in the network; and
a controller that, when the operation mode of the communicator is the first mode, decides based on the communication quality information whether to set the operation mode of the communicator to the second mode.

2. The apparatus according to claim 1, wherein when the operation mode of the communicator is the first mode, the controller decides to set the operation mode of the communicator to the second mode under a condition that a change in the communication quality information for a unit period satisfies a predetermined criterion.

3. The apparatus according to claim 1, wherein the communication quality information indicates the total number of links whose communication quality in the network is not lower than a threshold.

4. The apparatus according to claim 1, wherein when the operation mode of the communicator is the first mode, the controller decides to set the operation mode of the communicator to the second mode under a condition that a change amount of the total number of links of the communication quality not lower than a threshold in the network for a unit period is not larger than a predetermined value.

5. The apparatus according to claim 1, wherein when the operation mode of the communicator is the first mode, the controller decides to set the operation mode of the communicator to the second mode under a condition that a change amount of the total number of communication apparatuses connected to the communicator in the network is not larger than a predetermined value.

6. The apparatus according to claim 1, wherein when deciding to set the operation mode of the communicator to the second mode based on the communication quality information, the controller causes the communicator to transmit a first notification indicating a change in the operation mode of the communicator to another communication apparatus in the network before setting the operation mode of the communicator to the second mode.

7. The apparatus according to claim 1, wherein
the acquisition unit further acquires preliminary master device information indicating at least whether another communication apparatus capable of functioning as the hub of the network exists, and
when deciding to set the operation mode of the communicator to the second mode based on the communication quality information, the controller decides again to set the operation mode of the communicator to the second mode under a condition that the preliminary master device information indicates that another communication apparatus capable of functioning as the hub of the network exists in the network.

8. The apparatus according to claim 7, wherein when deciding again to set the operation mode of the communicator to the second mode based on the preliminary master device information, the controller causes the communicator to transmit a first notification indicating a change in the operation mode of the communicator to another communication apparatus in the network before setting the operation mode of the communicator to the second mode.

9. The apparatus according to claim 1, wherein when deciding to set the operation mode of the communicator to the second mode based on at least the communication quality information, the controller causes the communicator to transmit a second notification containing information for identifying a communication apparatus to function as a new hub of the network to another communication apparatus in the network before setting the operation mode of the communicator to the second mode.

10. The apparatus according to claim 1, wherein the controller selects a communication apparatus to function as a new hub of the network from communication apparatuses connected to the communicator.

11. The apparatus according to claim 1, wherein
the acquisition unit further acquires preliminary master device information indicating at least whether another communication apparatus capable of functioning as the hub of the network exists in the network,
when deciding to set the operation mode of the communicator to the second mode based on the communication quality information, the controller decides again to set the operation mode of the communicator to the second mode under a condition that the preliminary master device information indicates that at least one of communication apparatuses connected to the communicator is capable of functioning as the hub, and
the controller selects a communication apparatus to function as a new hub of the network from the communication apparatuses connected to the communicator.

12. The apparatus according to claim 1, wherein
the communicator performs wireless communication, and
the communication quality information indicates the communication quality of each wireless link in the network.

13. A communication system comprising:
a communication control apparatus and one or more communication apparatuses, wherein
each of the one or more communication apparatuses comprises a communicator that, when an operation mode is a first mode, functions as a hub of a network to communicate with another communication apparatus in the network, and when the operation mode is a second mode, communicates with another communication apparatus in the network without functioning as the hub of the network, and
the communication control apparatus comprises:
an acquisition unit configured to acquire communication quality information indicating a communication quality of each link in the network; and
a controller that, when the operation mode of the communicator of one of the one or more communication apparatuses is the first mode, decides based on the communication quality information whether to set the operation mode of the communicator to the second mode.

14. An energy management apparatus comprising:
a communicator that, when an operation mode is a first mode, functions as a hub of a network to communicate with another communication apparatus in the network, and when the operation mode is a second mode, communicates with another communication apparatus in the network without functioning as the hub of the network;
an acquisition unit configured to acquire communication quality information indicating a communication quality of each link in the network;
a controller that, when the operation mode of the communicator is the first mode, decides based on the communication quality information whether to set the operation mode of the communicator to the second mode; and
a management unit configured to manage measurement data about energy, and request the controller to transmit the measurement data.

15. The apparatus according to claim 14, wherein when the management unit requests to transmit the measurement data, the controller adjusts a timing of requesting the communicator to transmit the measurement data in accordance with a state of the network.

16. The apparatus according to claim 14, wherein the controller predicts a probability that the management unit requests to transmit the measurement data, and changes the operation mode of the communicator while the probability is not higher than a threshold.
